(19) United States
(12) Patent Application Publication
(10) Pub. No.: US 2003/0046226 A1
(43) Pub. Date: Mar. 6, 2003

(54) System and method for electronic funds transfers

(75) Inventors: Toshiyuki Iue, Yamato-shi (JP); Fuminori Ishikawa, Sagamihara-shi (JP)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/217,053

(22) Filed: Aug. 12, 2002

(30) Foreign Application Priority Data
Aug. 29, 2001 (JP) 2001-259845

(51) Int. Cl. G06F 17/60

(52) U.S. Cl. 705/39

(57) ABSTRACT

A transfer request is initiated by the owner of a target account at a device connected to a target server. The transfer request is transferred via a network to a source server for the source account from which the funds are to be transferred. Information in the transferee-initiated transfer request is then available to the transferor to fully define the transaction.

### FIELD OF THE INVENTION

The present invention relates to electronic funds transfers and more particularly to an improved system and method of transferring funds electronically where both the transferor and the transferee use input devices such as personal computers or automatic teller machines (ATMs) to implement the transaction.

### BACKGROUND OF THE INVENTION

When an account holder uses an ATM device or a network-connected personal computer to authorize the transfer of funds from his or her account to a designated recipient's account, the account holder must specify the bank holding the designated recipient's account, the recipient's account number and the value of the funds that are to be transferred.

All of the required data must be entered manually, which may be aggravating to the account holder and may result in entry of erroneous data. Clearly, the entry of erroneous data can create many problems, such as the transfer of the wrong amount of money, the transfer of the right amount of money but to the wrong account, etc. No financial institution wants aggravated customers or to have to incur the expense of correcting errors stemming from a customer's improper entry of data.

To reduce the possibility of problems, some financial institutions will furnish a machine-readable transfer card to its customer after the customer's first authorization of a transfer to a particular recipient account. The transfer card includes the recipient account number and can be used for subsequent transfers to the same account. However, the data that is recorded on the transfer card must still be entered manually at least once and the issuance of the transfer card is a burden on the financial institution.

A service has been implemented under which the recipient provides the necessary transfer card to the funds transferor. The transferor must personally present the transfer card to a teller (a bank clerk) who then performs the accounting procedures required for the transaction. While the funds transferor no longer has the burden of manually entering the transferee's account data, the transferor accepts the burden of taking the transfer card to the financial institution during normal business hours. This new burden may be more aggravating than the original burden.

Aside from the foregoing, the prior art process can make it difficult for a transferee to track a transaction where the transferor uses multiple accounts to fund the transfer. While the transferee may receive notice that numerous payments are being received from different accounts, nothing in the received information makes it easy for the transferee to correlate the different payments to the same transaction.

### SUMMARY OF THE INVENTION

According to the present invention, the owner of a target account initiates a funds transfer by authorizing a target server to send a transfer request to a source server supporting the source account. The transfer request, typically entered at an ATM device or network-connected personal computer, is relayed to a source server managing the source account. When a source account owner or transferor later accesses the source account through an ATM device or network-connected personal computer, the source server sends the transferor the transfer request information previously received from the target server. The delivery of the transfer request information effectively notifies the transferor that the target or transferee is anticipating consummation of the transaction. The transferor can then use the transfer request information originally provided by the target account owner to easily and accurately complete authorization of the transfer of funds from the source account to the target account.

Since the transferee initiates the transaction by providing transfer request information for use by the transferor, the transferee has the option of specifying that the funds be transferred to more than one target account.

### BRIEF DESCRIPTION OF THE DRAWINGS

FIG. 1 is a diagram showing the configuration of a funds transfer system according to one embodiment of the present invention.

FIG. 2 is a flowchart showing the processing performed by an ATM when a request source employs the ATM.

FIGS. 3A to 3C are diagrams showing example contents displayed by the ATM for the request source.

FIG. 4 is a flowchart showing the processing performed by the ATM to issue a transfer request.

FIG. 5 is a flowchart showing the processing performed by the server of a request source that receives a transfer request.

FIG. 6 is a flowchart showing the processing performed by the server of a request destination that receives a transfer request.

FIG. 7 is a flowchart showing the processing performed by an ATM when a request destination that receives a transfer request employs the ATM.

FIGS. 8A and 8B are diagrams showing example contents displayed by the ATM for a request destination.

FIG. 9 is a flowchart showing the processing for confirming the transfer request.

FIG. 10 is a diagram showing the data transmission from the time a transfer request is issued until it is approved or rejected.

FIG. 11 is a flowchart showing the processing performed to reject a transfer request.

FIG. 12 is a flowchart showing the processing performed when a request destination transmits a received transfer request.

FIG. 13 is a diagram showing the data transmission for transmitting a received transfer request.

FIG. 14 is a flowchart showing the processing for dividing a transfer request at a request destination.

FIG. 15 is a diagram showing the data transmission when a transfer request is divided.

FIG. 16 is a flowchart showing the processing performed when the server of a request source receives an approval notification in response to a transfer request.

FIG. 17 is a diagram showing the data transmission when an approval notification or a rejection notification is received in response to a transfer request.

FIG. 18 is a flowchart showing the processing performed when a server receives a rejection notification in response to a transfer request.

FIG. 19 is a diagram showing the data transmission when a rejection notification is received from a transmission destination or a division destination in response to a transfer request.

### DESCRIPTION OF PREFERRED EMBODIMENT

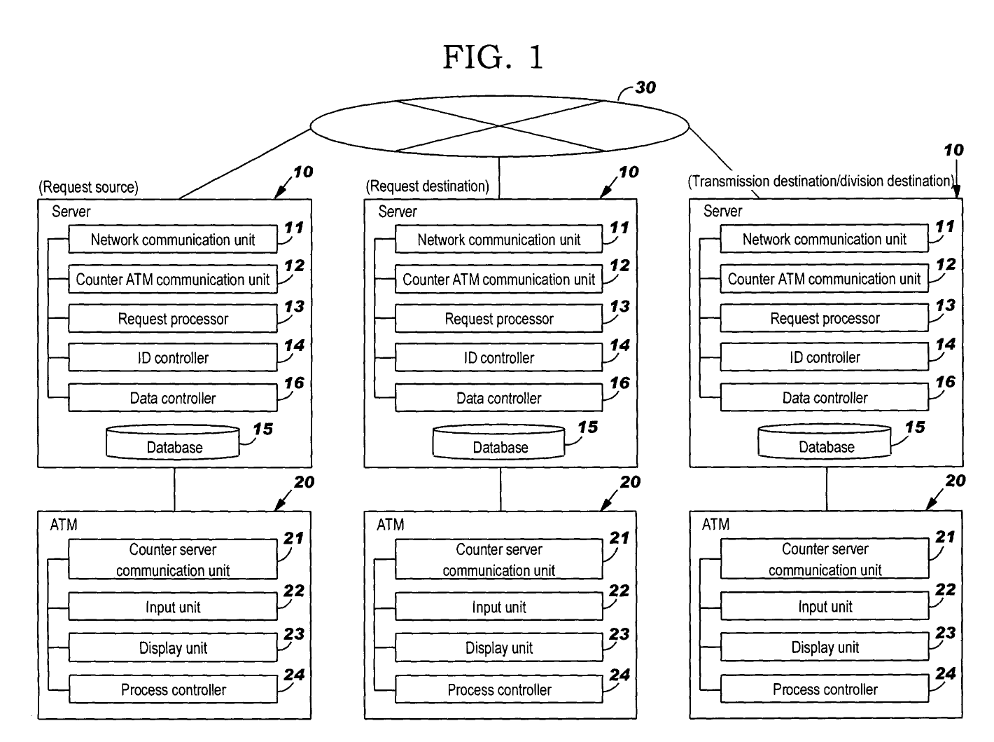

FIG. 1 is a diagram of a funds transfer system according to one embodiment of the present invention. In this embodiment, a request for a funds transfer into a target account is actually initiated by the intended recipient of the funds. The transfer request is transmitted through a network for storage at the financial institution having custody of the account from which the funds are to be transferred; that is, the source account. When the owner of the source account later submits an authorization for transfer of funds to the target account, information in the stored transfer request is then used to fully define the transaction.

It is expected that both the transferee and the transferor will normally interact with the system through remote devices such as ATM devices or terminals 20 connected through local servers 10 and a network 30 to a server 10 at the financial institution having custody of the source account. Each ATM device 20 may be conventional in nature, including a counter server communication unit 21 for communicating with the local server 10 on a dedicated line, a user input device 22, such as a touch panel, a display unit for displaying information and a process controller 24 for controlling the operation of the input/output devices.

Each of the servers 10 includes a network communication unit (transfer means) 11 for communicating with another server 10 via the network 30; a counter ATM communication unit (reception means) 12 for communicating with the ATM 20 connected to the server 10; a request processor (acceptance means) 13 for accepting a request issued by the ATM 20 or another server 10; an ID controller (identification information provision means) 14 for controlling an ID used for each transfer procedure; a database 15 in which various data are stored; and a data controller (response management means) 16 for controlling the input/output of data stored in the database 15.

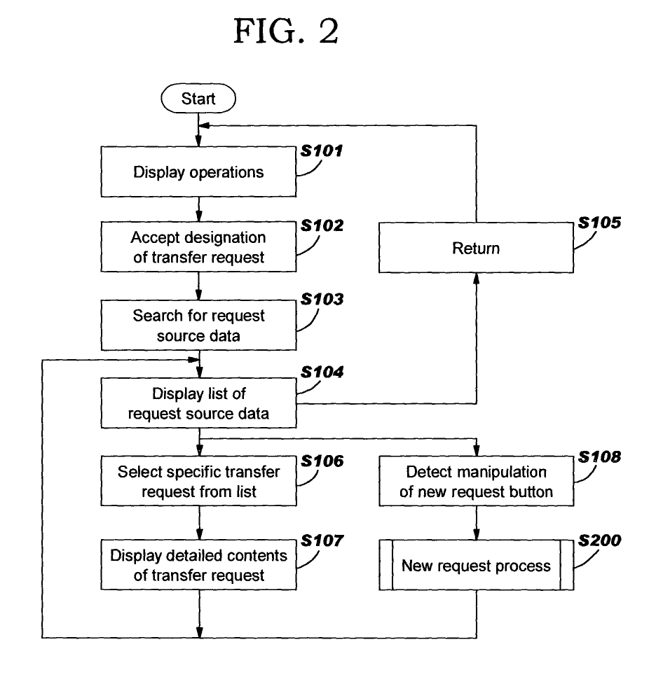

FIG. 2 shows the process that is performed when a transferee initiates a request for a transfer at an ATM device 20 connected to the target server 10. The transferee may initiate the request by inserting a cash cart into ATM 20 and selecting “transfer request” from a displayed menu of possible actions. The process controller 24 of the ATM 20 accepts the selected transfer request (step S102) by reading information about the target account from the inserted cash card. The process controller 24 employs the retrieved account information to request data from the server 10 via the counter server communication unit 21.

When server 10 receives the funds transfer request through counter ATM communication unit 21, the data controller 16 searches database 15 to obtain data that is correlated with the request source (step S103). The data controller 16 of the server 10 can then transmit the obtained data back to the display device for ATM 20 for presentation on the ATM user display (step S104).

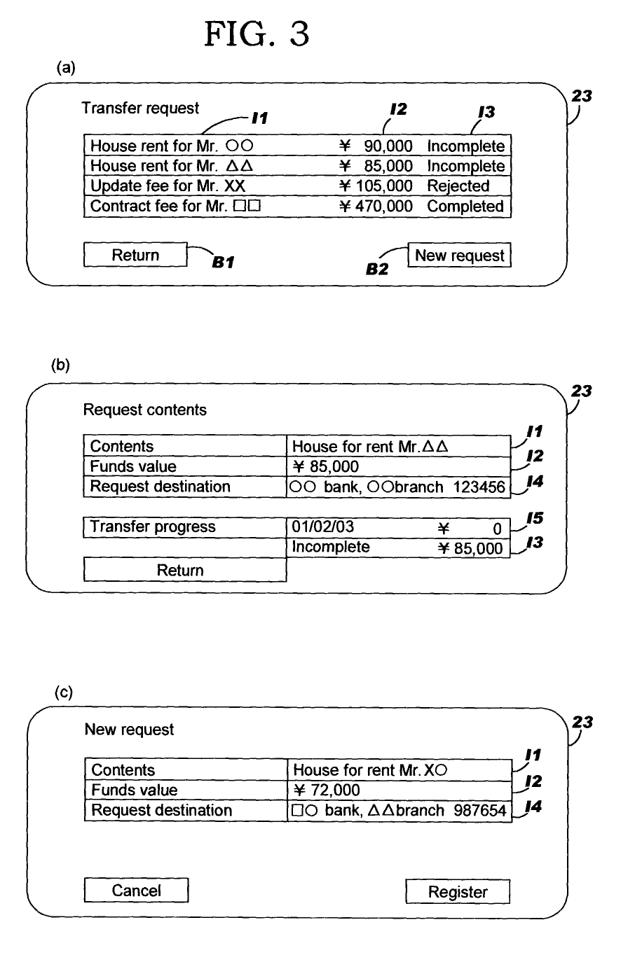

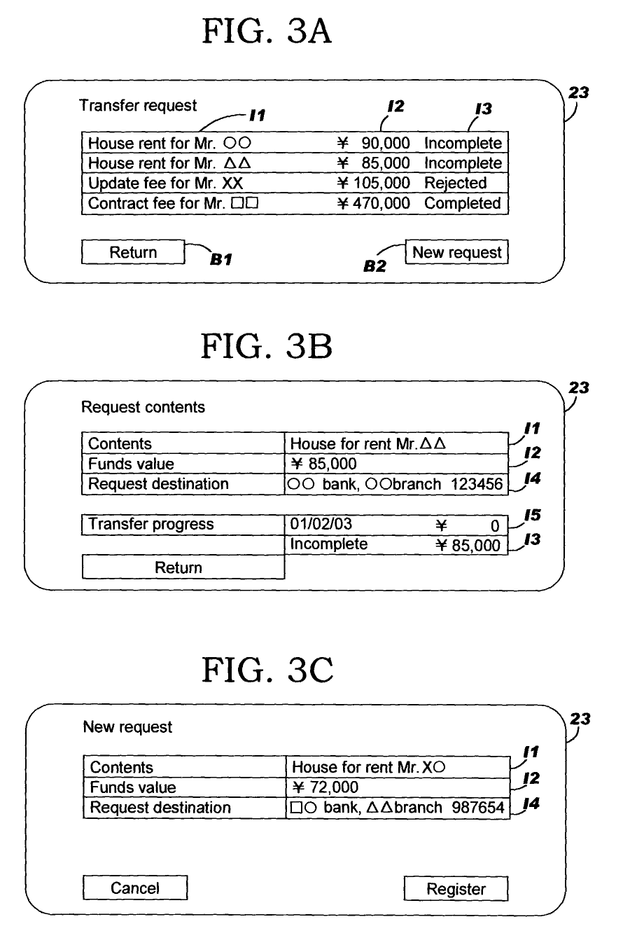

FIG. 3A is an example of information that can be displayed on the display unit 23 for after retrieval of database information. A list of transfer request states (overviews) is generated and displayed. This list includes contents I1 of a request, a funds value I2 requested be transferred and a status I3 for the listed transfer. The status I3 may be “incomplete” indicating that a money transfer has not yet been completed, “rejected” indicating that a transfer was rejected, and “completed” indicating that all the requested funds have been transferred.

As will be described later, when money is transferred from multiple accounts, the display may indicate what portion of the total amount is covered by each listed transaction; for example, “½”.

When the transferee examines the display and is satisfied that it reflects all of the planned transactions, the transferee can complete any funds transfer request by selecting “return” button B1 on the display unit 23. Then, the ATM 20 returns (step S105) to the initial state at step S101.

When the transferee wants details about a specific transfer request, the transferee can select the desired transfer request by depressing a specific button (step S106). The ATM 20 responds by retrieving details of the selected transaction and displaying those details on the display unit 23.

FIG. 3B is a diagram showing example, detailed contents that are displayed for a transfer request. In this example, the displayed information includes the request contents I1, the funds value I2 to be transferred and the status I3 of the transfer request, but also includes information I4 for a transfer request destination and a transfer date I5 (step S107).

When the transferee wants to issue a new transfer request, the transferee selects a “new request” button B2 on the display unit 23 (step S108). Then, the ATM 20 performs a new request process that will be described later (step S200).

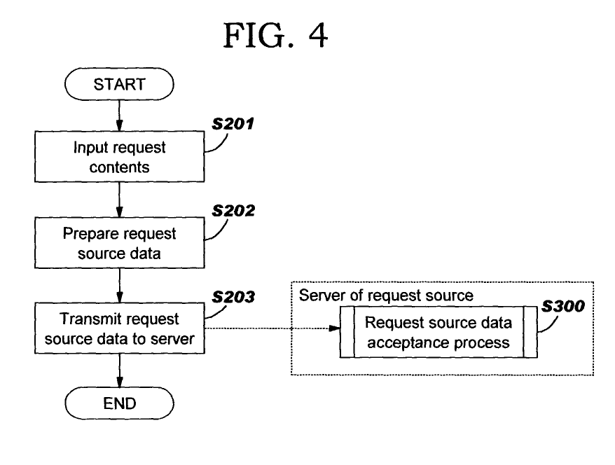

FIG. 4 is a flowchart showing the new request processing. First, the request source employs the input unit 22 of the ATM 20 to enter the contents of a request (step S201). As is shown in FIG. 3C, the items to be input are the request contents I1 (e.g., “house rent for XF”), the funds value I2 to be transferred and the information I4 for the request destination (information concerning another account). The information I4 for the request destination is, for example, the name of a request destination (a transferor who transfers money), the name of a bank that the transferor notifies the request source of in advance, and the branch number and the account number; however, an arbitrary information item may be employed so long as the account can be identified. Upon receiving the input data, the process controller 24 of the ATM 20 prepares request source data (step S202).

For this process in the ATM 20, information read from a cash card the request source inserted, or information transmitted by the server 10 at step S103 in FIG. 2, is employed to obtain request source information (account specification information), such as the name of the requesting source, the name of the bank, the branch number, the account number and the address of the server 10 of the bank. The request source information is added to the information input at step S201, and the request source data is prepared from these data. In addition, information indicating the date on which the data were generated is added to the request source data. The thus obtained request source data is transmitted through the counter server communication unit 21 to the server 10 connected to the ATM 20 (step S203). The request source data can also be prepared by the server 10, instead of the ATM 20.

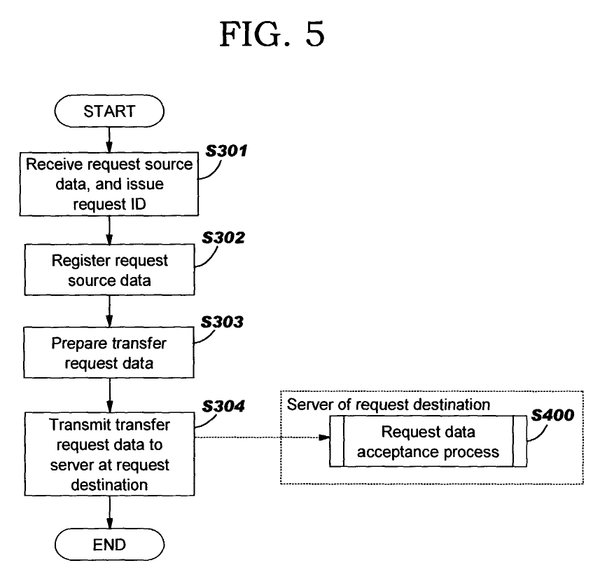

When the counter ATM communication unit 12 receives the request source data, the server 10 performs a request source data acceptance process that will be described later (step S300). FIG. 5 is a detailed flowchart showing the request source data acceptance processing. First, in the server 10, the ID controller 14 issues a request ID (personal identification information) for the request source data received from the ATM 20 (step S301). The data controller 16 correlates the request ID with the request source data received from the ATM 20, and stores (registers) the resultant data in the database 15, together with the accumulated data that is correlated with the request source (step S302).

Following this, based on the request source data, the server 10 transfers request data (transfer request information) relative to the request destination (step S303). The request ID, the request contents, the funds value, the request destination information, the request source information and the request occurrence date, all of which are provided for a request, are copied from among the request source data, and the server ID provided for the server 10 is added to the copied data. After the transfer request data has been thus prepared, the server 10 specifies the source server 10 of the bank whereat the account of the request destination that is included in the transfer request data is held, and transmits the transfer request data to the server 10 via the network 30 (step S304). As a result, the contents of the transfer request the request source entered using the ATM 20 are transmitted to the server 10 at the request destination.

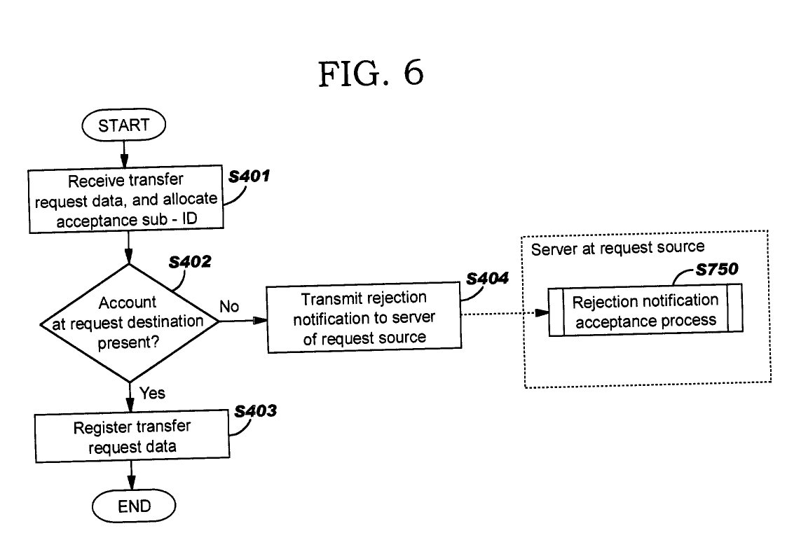

When the server 10 at the request destination receives the transfer request data via the network 30, the server 10 performs the transfer request data acceptance processing (step S400) in FIG. 6. That is, first, the server 10 allocates an acceptance sub ID (SubID) for the received transfer request data (step S401). Then, the server 10 determines whether the account of the request destination included in the transfer request data is present among the data stored in the database 15 of the server 10 (step S402). If the account is present, the transfer request data is registered, together with the accumulated data correlated with the account (step S403). When the account of the request destination is not present among the data in the database 15, the server 10 at the request destination transmits a rejection notification via the network 30 to the server 10 at the request source (step S404).

When the account of the request destination is the account of a destination for which the transfer request is divided or is transmitted, the server 10 at the transmission destination or the division destination transmits a rejection notification to the request source server, i.e., the server 10 at the transmission source or the division source. The server 10 of the request source that receives the rejection notification performs a predetermined rejection notification acceptance process at step S750. Since the contents of the rejection notification acceptance process at step S750 are the same as a process performed upon the reception of a rejection notification that is generated when the transfer request is rejected, which will be described later, both of these processes will be explained later.

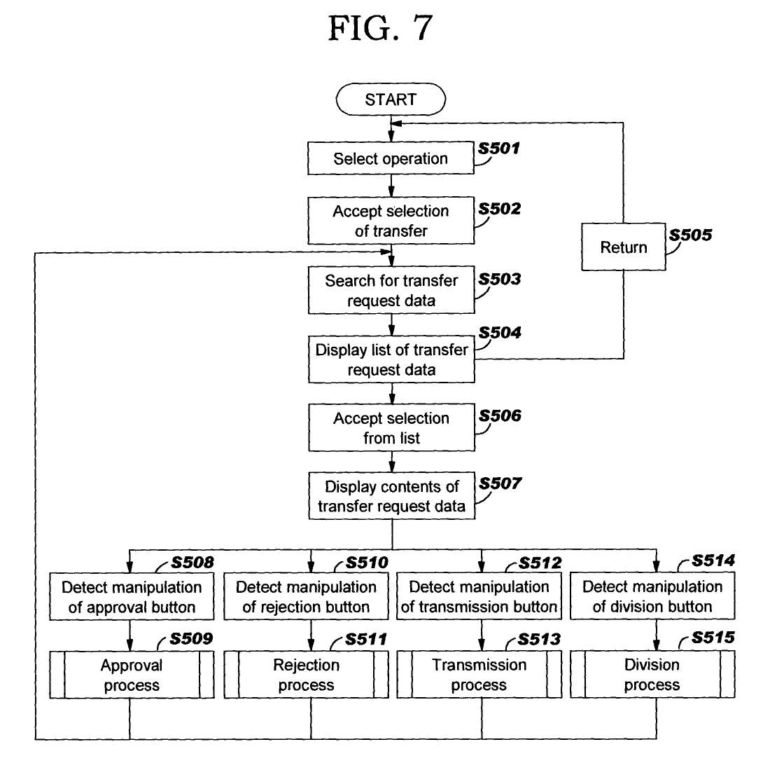

An explanation will now be given, while referring to FIG. 7, of a case wherein a transferor (a client who transfers funds) at a request destination employs the ATM 20 at an appropriate time following the reception by the server 10 at the request destination of the transfer request from the request source. First, when the funds transferor inserts his or her cash card into the ATM 20, the ATM 20 initially displays, on the display unit 23, a menu of various operations, such as deposit, withdrawal, funds transfer and bankbook updating (step S501). When the transfer client employs the input unit 22 to select funds transfer from among these operations, the process controller 24 of the ATM 20 accepts the designation (step S502), reads from the cash card inserted by the funds transferor identification information (information concerning the account of the client) such as the account number of the funds transferor, of the pertinent client that is registered in advance, and employs the identification information to forward a data inquiry to the server 10 via the counter server communication unit 21.

When the server receives the inquiry from the counter ATM communication unit 21, based on the identification information received from the ATM 20, the data controller 16 searches the database 15 to obtain transfer request data for the funds transferor (step S503). The data controller 16 of the server 10 then transmits, through the counter ATM communication unit 12 to the ATM 20, the obtained request transfer data for the funds transferor. When the ATM 20 receives the data from the server 10 via the counter server communication unit 21, based on the received data, the process controller 24 displays, on the display unit 23, the list of the request transfer data for the funds transferor (step S504).

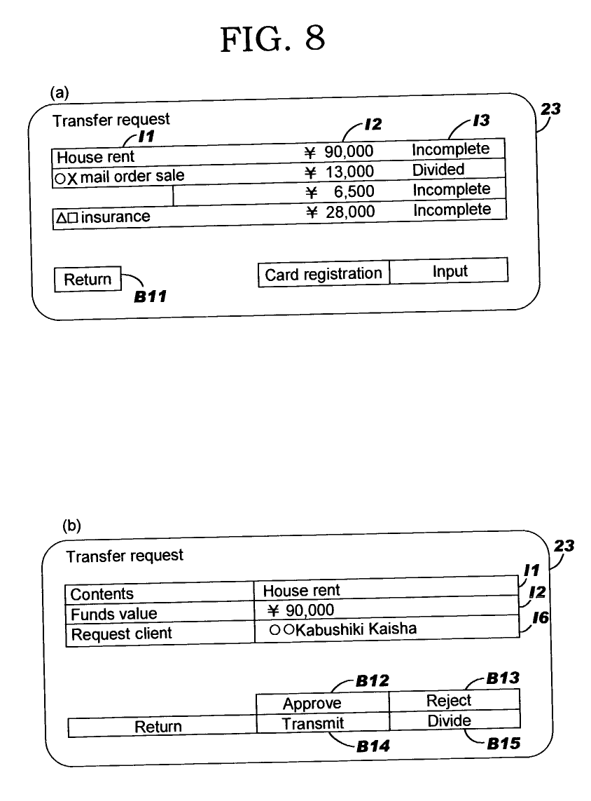

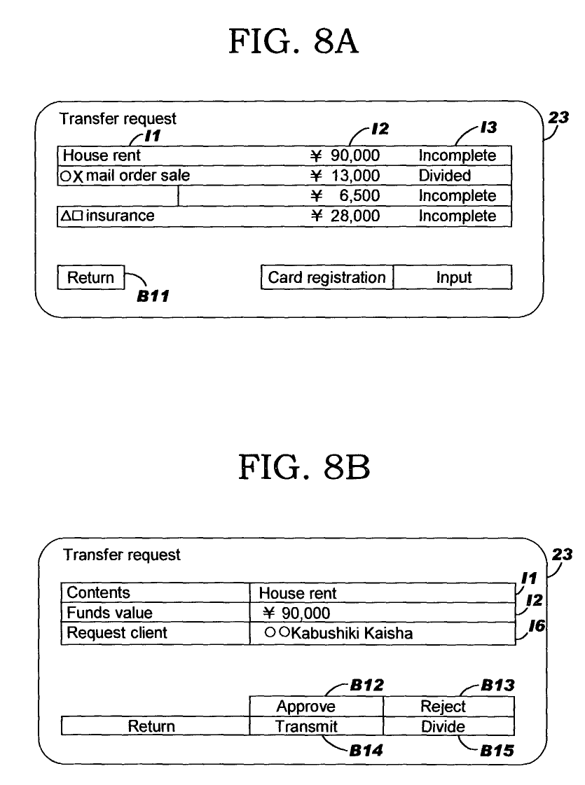

FIG. 8A is a diagram showing an example list of transfer request data for the funds transferor that is displayed on the display unit 23. The information for predetermined items is extracted from the transfer request data for the funds transferor, and the list of transfer request progresses (overviews) is formed and displayed. This list includes the request contents I1, funds value I2 for which the transfer was requested, and the transfer performance I3 relative to the transfer request. For the transfer performance I3, identification information, such as “incomplete”, can be displayed when a transfer has not been completed. As will be described later, when the funds transfer request is distributed to multiple accounts, the identification information “divided” may be displayed.

When the funds transferor examines the displayed list and does not need to perform the transfer process, e.g., when the client desires simply to confirm the transfer progress or does not currently intend to transfer funds, the funds transferor manipulates the “return” button B11 on the display unit 23. Then, the ATM 20 again displays the operation display screen at step S501 (step S505). When the request source intends to perform a specific transfer, the funds transferor selects a specific transfer request by, for example, touching the portion (area) of the list wherein the specific transfer request is displayed (step S506). Upon receiving this designation, the ATM 20 employs the data received from the server 120 to display, on the display unit 23, the detailed contents of the designated transfer request. FIG. 8B is a diagram showing example detailed contents that are displayed for the transfer request. In this example, the request contents I1, the transfer requested funds value I2 and the information item (name) 16 for the transfer request source are displayed (step S507). At this time, since an “approve” button B12, a “reject” button B13, a “transmit” button B14 and a “divide” button B15 are displayed, they can be used to designate, in response to the transfer request, the action for the funds transfer request.

When the input unit 22 detects the manipulation on the display unit 23 of the “approve” button B12 by the funds transferor, the process controller 24 notifies the server 10 of this designation, and the request processor 13 of the server 10 performs an approval process that will be described later (steps S508 and S509). Similarly, when the input unit 22 detects the manipulation of the “reject” button B13 by the funds transferor, the request processor 13 of the server 10, when notified of this selection, performs a rejection process that will be described later (steps S510 and S511). However, when the input unit 22 detects the manipulation of the “transfer” button B14, the request processor 13 performs the transmission process (steps S512 and S513), and when the input unit 22 detects the manipulation of the “divide” button B15, the request processor 13 performs the division process (steps S514 and S515).

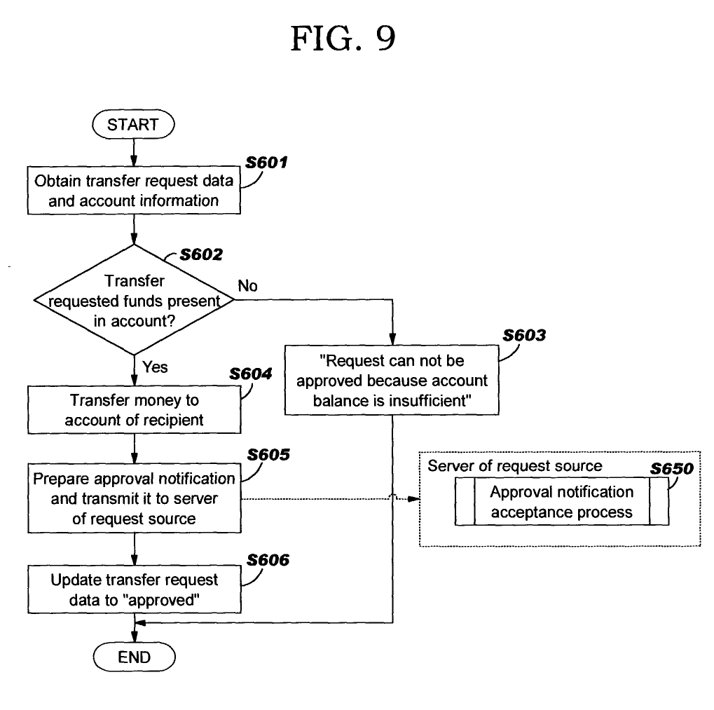

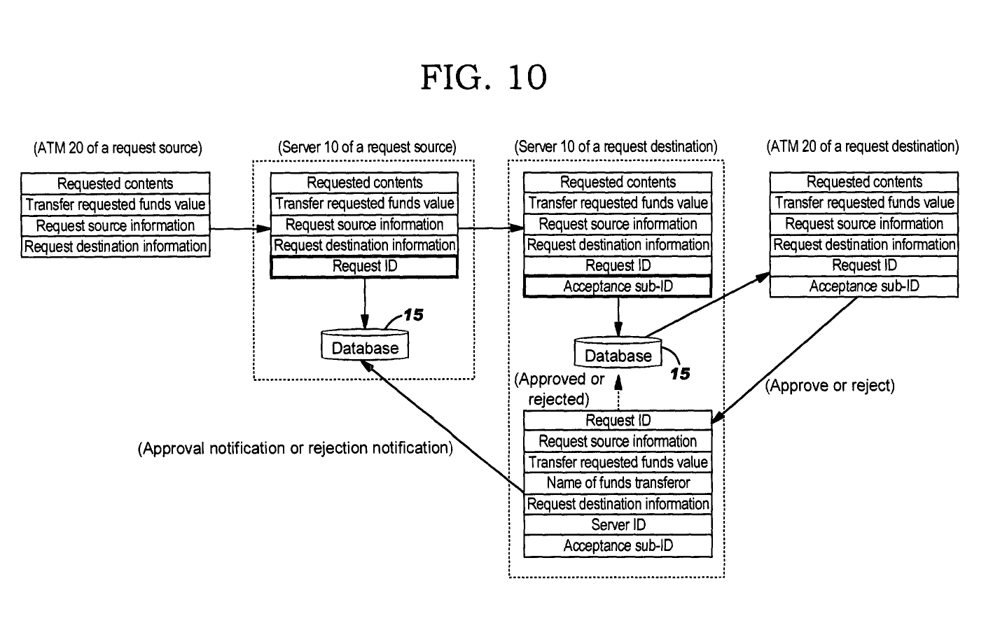

FIG. 9 is a detailed flowchart showing the approval process at step S509, and FIG. 10 is a diagram showing the data processing performed from the time the above described transfer request is issued until it is approved. First, upon receiving the notification from the ATM 20, the request processor 13 of the server 10 of the funds transferor obtains, from the database 15, the designated transfer request data and the information concerning the account of the funds transferor, such as the account balance (step S601). Then, the request processor 13 compares the account balance of the funds transferor with the transfer requested funds value I2 included in the obtained transfer request data, and determines whether the balance in the account is equal to or greater than the transfer requested funds value I2 (step S602). When the balance is less than is required, the request processor 13 notifies the ATM 20, and the ATM 20 displays, on the display unit 23, a message that “request can not be approved because account balance is insufficient.” (step S603). The approval process is thereafter terminated. In this case, of course, the approval of the transfer request is incomplete.

When the balance in the account is equal to or greater than the transfer requested money value I2, the request processor 13 performs the transfer process for the account request source (transferee). For this transfer process, the request processor 13 obtains from the request source information included in the transfer request data, the bank of the request source, the branch number, the account number and the transfer requested funds value I2, and as for a normal transfer process, requests from the host (not shown) of an accounting system the transfer to the account of the request source (transferee), following which the host of the accounting system performs the transfer process (step S604).

Furthermore, the request processor 13 also prepares an approval notification. For this process, the request processor 13 copies from the request source information included in the transfer request data the request ID, the bank of the request source, the branch number, the account number and the funds value I2 for the requested transfer, and adds to the obtained information the name of the funds transferor, the server ID provided for the server 10 and the acceptance sub-ID provided for the transfer request data. The request processor 13 then permits the network communication unit 11 to transmit the thus prepared approval notification to the server 10 of the request source via the network 30 (step S605), and updates the “progress” entry for the transfer request data to “approved” (step S606). When the server 10 at the request source receives the approval notification from the server 10 of the funds transferor via the network 30, at step S650 the server 10 performs an approval notification acceptance process that will be described in detail later.

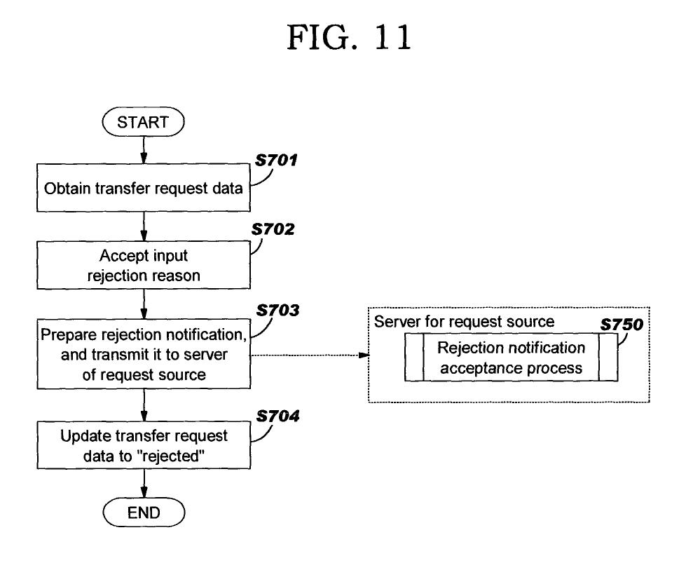

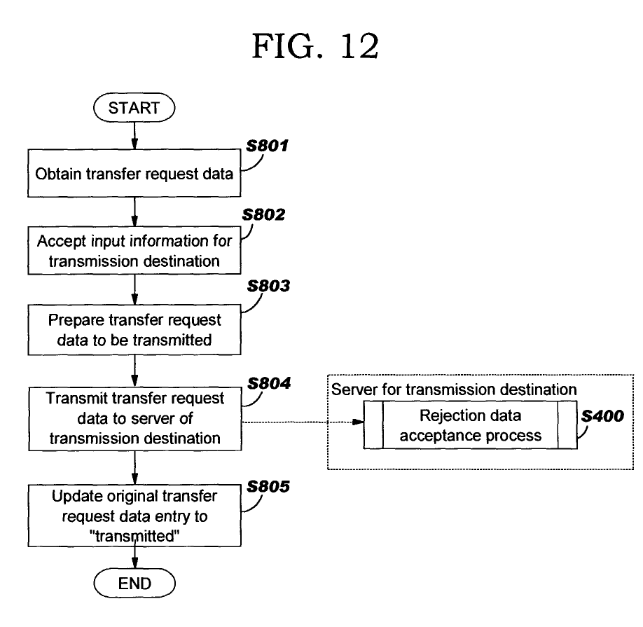

FIG. 11 is a detailed flowchart showing the rejection process at step S511. Also shown in FIG. 10 is the data processing performed from the time the above transfer request is issued until it is rejected. First, upon receiving the notification from the ATM 20, the request processor 13 of the server 10 of the funds transferor obtains the designated transfer request data from the database 15 (step S701). The ATM 20 displays, on the display unit 23, the screen for requesting that the funds transferor input the reason for the rejection of the transfer request. When the funds transferor enters the rejection reason by using the input unit 22, the process controller 24 of the ATM 20 transmits this information to the server 10 (step S702).

The request processor 13 of the server 10 thereafter prepares a rejection notification. For this process, the request processor 13 copies the request ID, the bank of the request source, the branch office, the account number and the transfer requested money value I2 from the request source information included in the transfer request data, and adds to the obtained information the name of the funds transferor (the rejection source), the server ID provided for the server 10 and the acceptance sub-ID provided for the transfer request data. The request processor 13 then permits the network communication unit 11 to transmit the thus prepared rejection notification via the network 30 to the server 10 of the request source (step S703), and updates the “progress” entry for the transfer request data to “rejected” (step S704). Thereafter, when the server 10 at the request source receives the rejection notification from the server 10 of the funds transferor via the network 30, at step S750 the server 10 performs a rejection notification acceptance process that will be described later. For the transmission and the division that will be described later, it is preferable that the rejection notification not be transmitted to the request source, but that it be transmitted to the transmission source or the division source, so that the funds transferor at the transmission source or the division source can determine the process to be performed following the rejection.

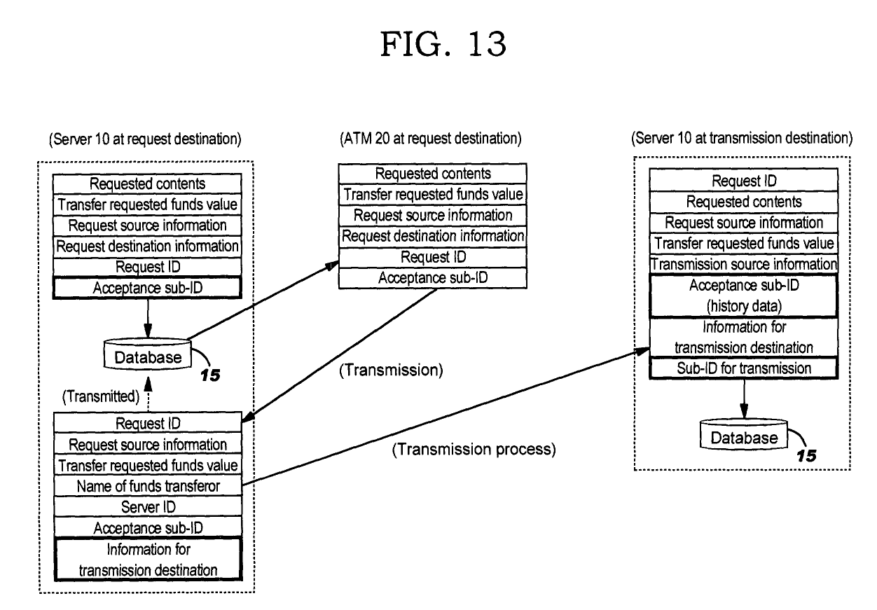

FIG. 12 is a detailed flowchart showing the transmission processing at step S513 that is performed by the server 10 and the ATM 20. FIG. 13 is a diagram showing the data processing performed by this transmission process. This transmission process is performed when the request destination (funds transferor) desires to transfer funds from a different account in accordance with the transfer request, or when the funds transferor transmits the request transfer to another client. In this case, first, upon receiving the notification from the ATM 20, the request processor 13 of the server 10 obtains the designated transfer request data from the database 15 (step S801). The ATM 20 then displays, on the display unit 23, the screen for requesting the entry of information concerning the transmission destination, and the client at the request destination enters necessary information concerning the transmission destination (step S802). The information concerning the transmission destination includes the name of the bank whereat the account of the transmission destination is held, the branch number and the account number; however, an arbitrary information item may be included so long as the account can be identified. When the request destination enters the information concerning the transmission destination using the input unit 22, the process controller 24 of the ATM 20 transmits this information to the server 10.

Further, the request processor 13 prepares transfer request data for transmission. For this process, the request processor 13 copies the request IS, the request contents, the request source information (the bank name, the branch office and the account number) and the transfer requested funds value from the request source information included in the original transfer request data, and adds to this obtained information the name of the funds transferor who requested the data transmission, the server ID provided for the server 10, the acceptance sub-ID provided for the transfer request data and the information concerning the transmission destination that is entered at step S802 (step S803).

The request processor 13 then permits the network communication unit 11 to transmit the thus prepared transfer request data to the server 10 at the destination via the network 30 (step S804), and updates the “progress” entry for the original transfer request data to “transmitted” (step S805). When the server 10 at the transmission destination receives the transfer request data from the server 10 of the funds transferor along the network 30, the server 10 at the destination performs the request data acceptance process at step S400. At this time, at step S401, the server 10 at the destination adds a new transmission sub-ID (personal identification information) to the transfer request data for transmission. When the transfer request destination that receives the original transfer request data and the transmission destination for the transfer request data are at the same bank branch office, it is possible to prevent multiple sets of transfer request data having the common request ID from being present in the same server 10. At this time, the acceptance sub-ID is retained as history data in the transfer request data.

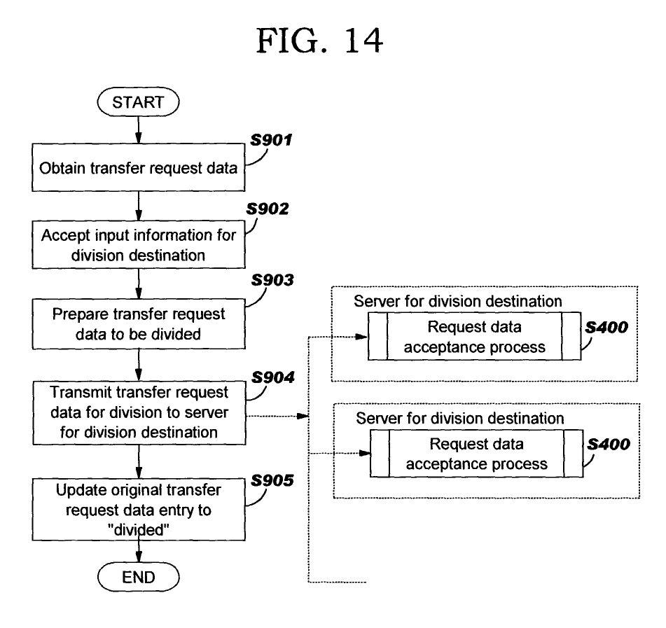

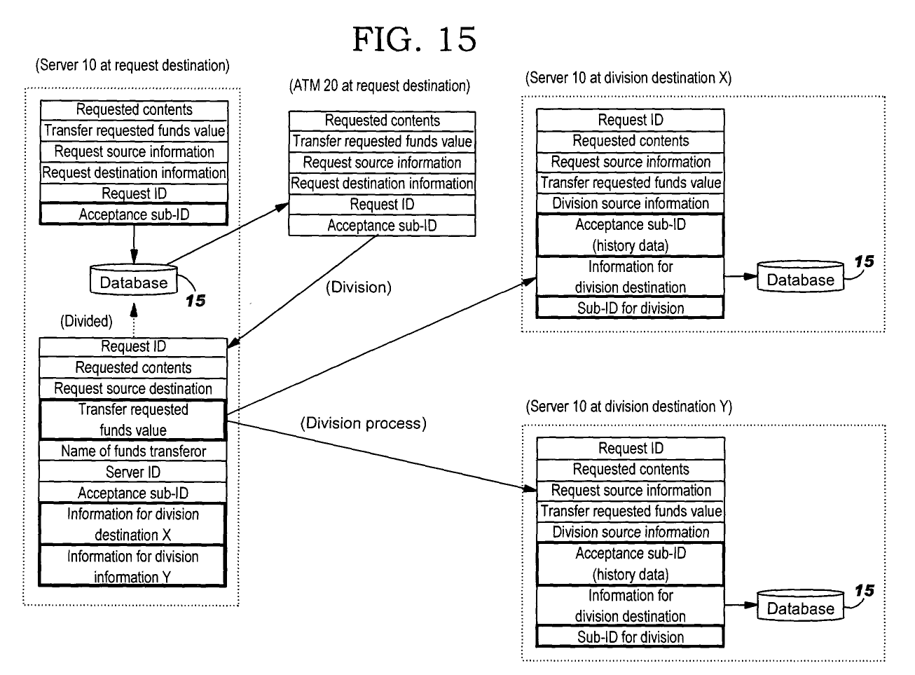

FIG. 14 is a detailed flowchart showing the division process at step S515, and FIG. 15 is a diagram showing the data transmission process performed during the division process. This division process is performed when the transfer request destination (funds transferor) desires to share the 26 transfer request with a specific account and a different account of his own, or the account of another client so as to transfer funds as requested. In this case, first, upon receiving the notification from the ATM 20, the request processor 13 of the server 10 obtains the designated transfer request data from the database 15 (step S901). The ATM 20 then displays, on the display unit 23, the screen for the entry by the request destination of information concerning the division destination, following which the request destination enters required information concerning the division destination (step S902). The information concerning the division destination includes the items used to identify an account, such as the name of the bank whereat the account of the division destination is held, the branch number and the account number, and the funds value that it is requested be transferred from several sharing destinations. Any number may be employed for the distribution of the transfer request, and information concerning the division destinations need only be entered in accordance with the number that is employed. When the request destination enters the information concerning the division destination using the input unit 22, the process controller 24 of the ATM 20 transmits this information to the server 10.

The request processor 13 then prepares the transfer request data to be divided. For this process, the request processor 13 copies the request ID, the request contents, the request source information (the bank name, the branch number and the account number) from the request source information included in the original transfer request data, and adds to the obtained information the name of the funds transferor who has requested the transmission of a transfer request, the server ID provided for the server 10, the acceptance sub-ID provided for the transfer request data for the division source, and the information concerning the transmission destination entered at step S902 (step S903).

The request processor 13 then permits the network communication unit 11 to transmit the thus prepared transfer request data for the division via the network 30 to the server 10 at the division destination (step S904), and updates the “progress” entry for the original transfer request data to “divided” (step S905). When the server 10 at the division destination receives the transfer request data from the server 10 of the funds transferor via the network 30, the server 10 at the destination performs the transfer request data acceptance process at step S400. At this time, at step S401 the server 10 of the division destination adds a new sub-ID (personal identification information) to the transfer request data. Thus, when the funds transferor who has received the original transfer request data and the division destination of the transfer request data for the same bank branch office, it is possible to prevent multiple sets of transfer request data having the common ID from being present in the same server 10. At this time, the acceptance sub-ID is retained as history data in the transfer request data to be transmitted.

The processes at steps S501 to 515 in FIG. 7 are also performed when the funds transferor, to whom the transfer request is transmitted or for whom it is divided through the above described transmission or division process, employs the ATM 20. That is, in the same manner, the funds transferor to whom the transfer request has been transmitted or for whom it has been divided selects either approval, rejection, transmission or division.

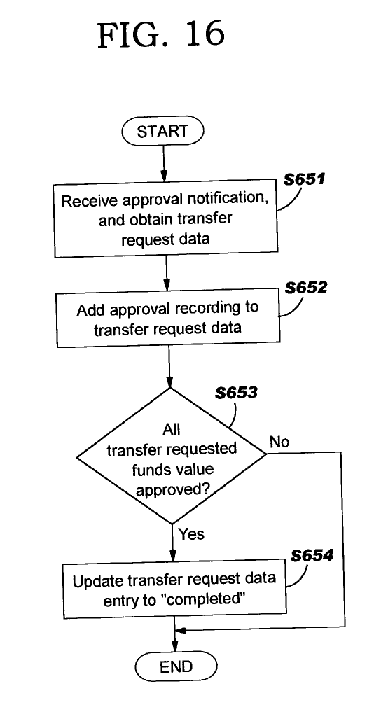

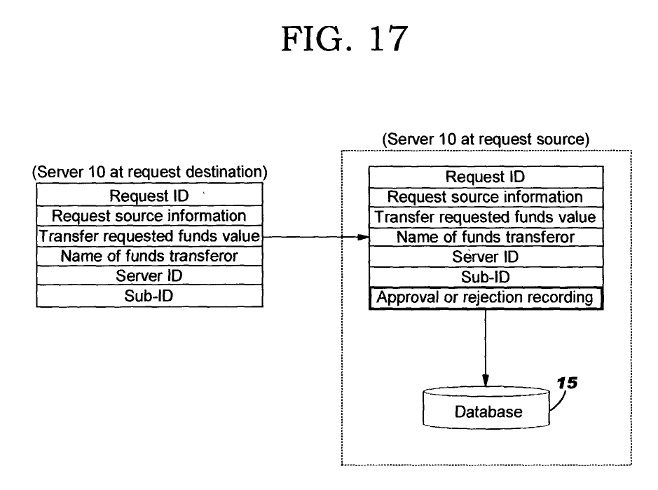

FIG. 16 is a flowchart showing the approval notification acceptance processing at step S650 that is performed by the server 10 at the request source when it receives during the above described approval processing, an approval notification from the server 10 of the funds transferor at step S605. FIG. 17 is a diagram showing the data transmission performed during this process. For the approval notification acceptance processing at step S650, first, the data controller 16 of the server 10 at the request source searches the database 15 based on the request ID included in the received approval notification, and obtains the original transfer request data (step S651). The “approval recording” entry indicating that the transfer request is approved is added to the transfer request data (step S652).

As was previously described, since there is a case where the transfer request is divided among several accounts, the server 10 at the request source determines whether all the transfer requested funds value I2 has been approved relative to the transfer request (step S653). When not all the transfer requested funds value I2 has been approved, the transfer request data is unchanged. But when all the transfer requested money value I2 has been approved, the “progress” entry for the transfer request data is updated to “completed”, which is then stored in the database 15 (step S654). The above process can be applied in the same manner not only for a funds transferor who receives a transfer request directly from a request source, but also for a client who serves as a funds transferor following the transmission or division of the transfer request by the original funds transferor.

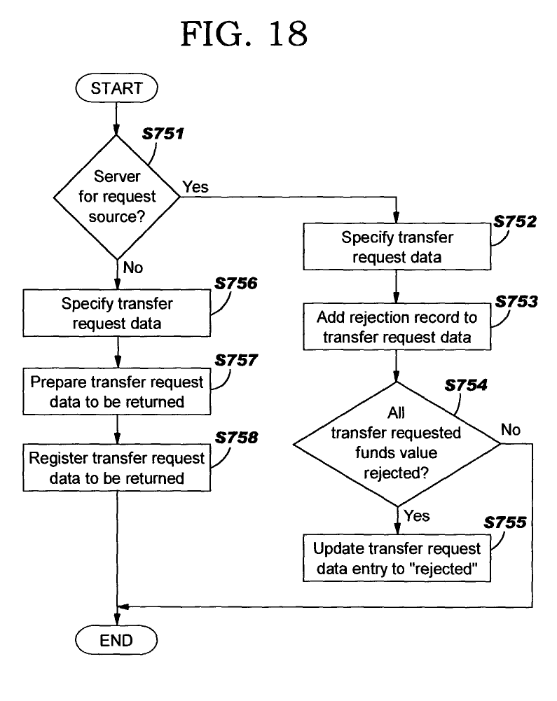

FIG. 18 is a flowchart showing the rejection notification acceptance processing at step S750 performed by the server 10 at the request source, the transmission source or the division source, when the server 10 receives at step S404 a rejection notification from the server 10 at the request destination during the transfer request data acceptance process, or when at step S703 the server 10 receives a rejection notification from the server 120 of the funds transferor during the rejection processing. For the rejection notification acceptance processing at step S750, first, a check is performed to determine whether the server 10 that has received the rejection notification matches the server 10 at the request source (step S751). During this process, whether the acceptance sub-ID is included as history data for the rejection notification is determined. When the acceptance sub-ID is not included, it is ascertained that the server 10 that has received the rejection notification is the server 10 at the request source. And when the acceptance sub-ID is included, it is ascertained that the server 10 that has received the rejection notification is the server 10 that received the rejection notification from the server 10 at the division destination or the transmission destination.

This is because when the transfer request is divided or transmitted, the acceptance sub-ID is retained as history data. That is, when the acceptance sub-ID is included as history data, the server 10 can be determined to be the server 10 that received the rejection notification from the server 10 at the division destination or the transmission destination, i.e., the server 10 that has divided or transmitted the transfer request.

When the decision at step S751 is Yes, i.e., when it is ascertained that the server 10 that received the rejection notification is the server 10 at the request source, the data is transmitted in the same manner as is shown in FIG. 17. In this case, based on the request ID included in the rejection notification, the data controller 16 of the server 10 searches the database 15 to obtain the transfer request data corresponding to the request ID (step S752). Then, the “rejection recorded” is added to the obtained transfer request data (step S753). Since as previously described there is also a case wherein the transfer request is divided, a check is performed to determine whether relative to the transfer request all the transfer requested funds value I2 has been rejected (step S754). When not all the transfer requested funds value I2 has been rejected, the transfer request data is unchanged and the processing is thereafter terminated. When all the transfer requested funds value I2 has been rejected, the “progress” entry for the transfer request data is updated to “rejected” (step S755).

When the decision at step S751 is No, i.e., when it is ascertained that the server 10 that received the rejection notification is not the server 10 at the request source, the server 10 is the one at the transmission source, or at the division source.

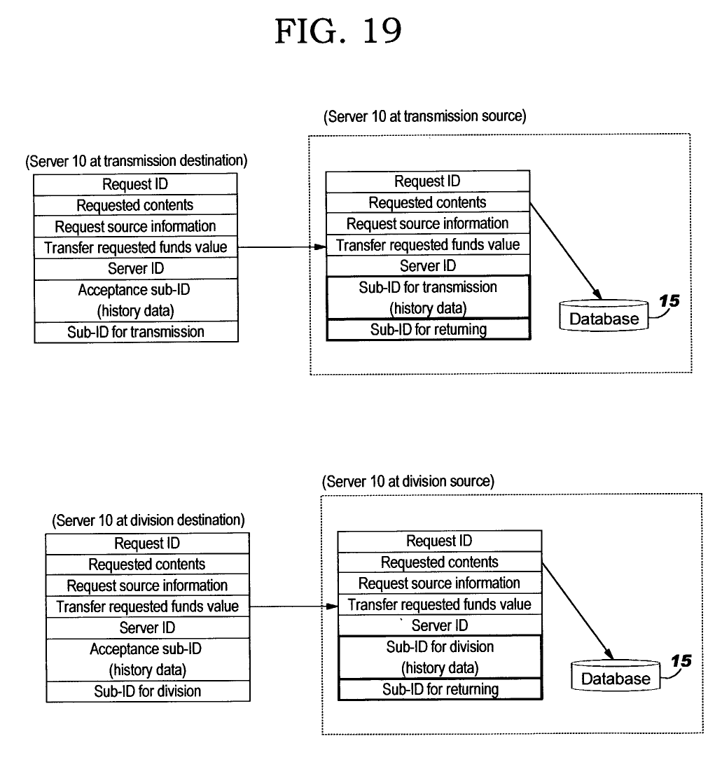

FIG. 19 is a diagram showing the data transmission performed during this processing. In this case, based on the request ID included in the rejection notification, the data controller 16 of the server 10 searches the database 15 to obtain the transfer request data corresponding to the request ID (step S756). Based on the obtained transfer request data, the server 10 prepares transfer request data with which the transfer request that has been rejected is returned to the server 10 of the division source or the transmission source (step S757).

For this process, the server 10 copies, from the transfer request data obtained at step S756, the request ID, the request contents, the bank name, the branch number and the account number of the request source, the name of the request destination, and the bank name, the branch office and the account number of the request destination, and further copies the transfer request funds value from the rejection notification. Then, the server 10 allocates a new return sub-ID for the transfer request data that includes the above described information and that is to be returned, and adds the resultant data to that transfer request data. Then, the server 10 registers, in the database 15, the transfer request data to be returned (step S758). Therefore, when the funds transferor to which the rejected transfer request is returned, i.e., the client who transmitted or divided the transfer request, employs the ATM 20 to perform the processing shown in FIG. 17, the funds transferor can be notified of arrival of this transfer request. Then, the funds transferor need only again perform the processing in FIG. 7 for the transfer request that is returned.

In the above described funds transfer system, the transferee requests a funds transfer from the funds transferor. Thus, the funds transferor need not enter the information for the transfer destination using the ATM 20, and can avoid the labor required to effect the transfer and can smoothly perform the transfer procedures without entering erroneous data. Furthermore, since the transfer process is performed through the confirmation step whereat the recipient requests the funds transfer and the funds transferor approves this request, such trouble as a transfer error can be prevented. In addition, since the request ID is added to the transfer request and is employed until the transfer is finally approved or rejected, each server 10 can identify the transfer request data, and the transferee can confirm the transfer. Further, in the above funds transfer system the transfer request side can transmit or divide a transfer request, so that for the funds transfer side usability is improved. Even when the transfer request is transmitted or divided, the recipient side can easily confirm the transfer of funds by using the request ID. Of course, since both the transferee and the funds transferor can employ the ATM 20 to perform the above described processes, the limit on the period of time that can be used can be reduced, and for this client, usability can be improved.

In this embodiment, when the funds transferor employs the ATM 20 to select a transfer from an operation menu, the information for the transfer request issued to this client is presented. The configuration, however, is not limited to this, and when the client inserts a cash card into the ATM 20, or when the client selects a deposit or withdrawal other than a transfer, the client may be notified of the arrival of a transfer request. The servers 10 on the request source (transferee) side and on the request destination (funds transferor) side may transmit e-mail indicating that the request source issued a transfer request to the request destination, or that the funds transferor has transferred funds to the transferee. The server 10, the ATM 20 and the terminal of a client for Net banking described include the functions for both the request source and the request destination.

Further, in the explanation of the embodiment, the request source and the request destination, or the request destination and the transmission destination or the division destination employ different servers 10 to exchange data. However, when, for example, the request source and the request destination are the same branch office, a single server 10 can perform a process for both the request source and the request destination, or for the request destination and the transmission destination or the division destination. In addition, the transferee, the original funds transferor, or the funds transferor at a transmission destination or the division destination, can employ not only the ATM 20, but also a terminal, such as a PC, through Internet banking to perform the above procedures. In addition, the individual detailed processes described above may be variously modified so long as the same functions are implemented. Furthermore, without departing from the scope of the invention, the configuration in the embodiment may be appropriately selected or may be variously modified to obtain another configuration.

What is claimed is:

1. A method of implementing an electronic transfer of funds from a source account managed by a source server to a target account manager by a target server, said method comprising the steps of:
accepting, at the target server, a request from the target account owner, that the funds transfer be initiated, said request including the account information needed to complete the transfer;
transmitting the funds transfer request from the target server to the source server; and
storing the funds transfer request at the source server.

2. A method as defined in claim 1 further including the following steps performed at the source server:
receiving a funds transfer authorization from the source account owner;
matching the funds transfer authorization to the stored funds transfer request previously received from the target server; and
using the information in the stored funds transfer request in combination with the funds transfer authorization to fully define the transaction.

3. A method as defined in claim 2 further including the steps, performed at the source server, of:
determining whether the fully defined transaction is approved by the financial institution that is custodian of the source account; and
responding to approval of the transaction by initiating the actual electronic transfer of funds from the source account to the target account.

4. A financial institution server for controlling the electronic transfer of funds from a source account under the custodial control of the financial institution to a target account, said server including:
request receiving logic for receiving a funds transfer request originating at a target server serving the target account, said funds transfer request including target account information;
a memory for storing received funds transfer requests; and
logic for retrieving a stored funds transfer request in response to a funds transfer authorization received from the source account owner.

5. A financial institution server as defined in claim 4 further including:
a database for storing information about the source account;
logic for combining information stored in the database with information in the stored funds transfer request.

6. A financial institution server as defined in claim 4 further including:
means for providing personal identification information for at least one party; and
means for utilizing the personal identification information in processing the transfer request.

7. A financial institution server as defined in claim 4 wherein the server further includes means for indicating whether a request has been approved or denied.

8. A financial institution server for managing a client account, said server including:
means for receiving transfer request information for said account of said client;
output means for outputting a notification of the presence of said transfer request information or the contents thereof;
request acceptance means for accepting a counter request to cope with a transfer request based on said transfer request information that is output; and
process execution means for performing a process consonant with said counter request.

9. A financial institution server according to claim 8 wherein said process execution means further includes means for initiating a transfer upon receipt of approval of a transfer request.

10. A financial institution server according to claim 8 wherein said process execution means includes means for sending a transfer rejection notification when a transfer request is rejected.

11. A funds transfer system comprising:
a target server for managing a target account; and
a source server for managing a server account, said target server and said source server being connected via a network,
wherein said target server includes means for receiving a transfer request and means for transmitting information in the received transfer request to the source server, said transfer request identifying a source account managed by the source server and a target account managed by the target server, and
wherein said source server includes means for accepting said transfer request information transmitted from said target server and a corresponding request from the owner of the source account.
